(19) United States
(12) Patent Application Publication
(10) Pub. No.: US 2017/0272789 A1
(43) Pub. Date: Sep. 21, 2017

(54) METHOD OF MANAGING CONTENTS IN A CONTENTS DISTRIBUTION NETWORK

(71) Applicant: ORANGE, Paris (FR)

(72) Inventors: Gael Fromentoux, Pleumeur Bodou (FR); Frederic Fieau, Paris (FR); Nathalie Omnes, Trebeurden (FR)

(21) Appl. No.: 15/529,062

(22) PCT Filed: Dec. 3, 2015
(86) PCT No.: PCT/FR2015/053317

§ 371 Date: May 23, 2017

(30) Foreign Application Priority Data
Dec. 4, 2014 (FR) 1461925

(51) Int. Cl. H04N 21/234; G06F 17/30; G06F 9/455

(52) U.S. Cl. CPC H04N 21/23418; G06F 9/45558; G06F 17/30233; G06F 2009/45595

(57) ABSTRACT

The invention relates to a method for managing contents in a contents distribution network (2) comprising physical resources (30, 40) able to host at least one virtualized delivery resource (31, 32, 41), the method comprising the following steps implemented by a management entity for a contents delivery service (10): obtaining (E2) of a listening parameter in relation to a content at the level of at least one of said physical resources able to host a virtualized delivery resource storing at least one fragment (61-64, 71) of said content; issuing (E4) of a command for adaptation of at least one virtualized delivery resource hosted by one of said physical resources as a function of said listening parameter.

The invention is positioned in the field of content distribution, and relates more particularly to the management of these contents in a content distribution network.

Faced with the substantial volumes of digital content sold today on the IP (Internet Protocol) telecommunications networks and the resulting huge increase in traffic, the operators of these networks have deployed hierarchical and organized architectures to manage the delivery of the contents on the basis of a variety of networked hardware resources. Hardware resources are understood to mean, for example, physical content servers and storage spaces deployed in the network. Architectures of this type are, for example, the content distribution network or CDN (Content Delivery Network) architectures described in document TS 182.019, entitled “Telecommunications and Internet Converged Services and Protocols for Advanced Networking (TISPAN): Content Delivery Network (CDN) Architecture”, v3.1.1, June 2011, published by ETSI. They are based on a collaborative set of components, including, in particular, origin servers on which the contents are hosted, and “mirror” hardware nodes (e.g. content servers) geographically distributed at the network edge and in which the contents are duplicated. This architecture enables the transparent and efficient distribution of the contents hosted by the origin servers to the users via the definition of a routing mechanism allowing a user to be served by the geographically closest mirror node of the network.

Today, we are furthermore witnessing the virtualization (i.e. the dematerialization) of the functions used in the telecommunications networks, referred to below as “telecoms” functions. These telecoms functions refer, for example, to the functions implemented by a network core, a gateway, a firewall, etc. This virtualization is implemented, in particular, by cloud computer systems, also more commonly referred to as the “cloud”, which implement and host these functions on virtual machines accessible, for example, via a network application. These virtual machines use remote computer resources and hardware networks (e.g. network connectivity, processing power, storage space, servers, applications, etc.) managed by the cloud computer system and shared among its different clients according to their respective requirements. The clients can thus access these resources in an open-ended manner, without having to administer the underlying resource infrastructure which manages these resources and is often complex.

A great deal of work is currently being carried out in the standardization bodies to provide a framework for this major technological evolution which the virtualization of the telecoms functions entails. This effort is also focused on content delivery as it is envisaged today in the CDN network architectures. With time, content delivery may thus be implemented not only on the basis of CDN network hardware architectures as deployed today, but also on the basis of “cloud” infrastructures. By taking advantage of the virtual resources offered by the “cloud” infrastructures, the CDN service is intended to evolve towards a service referred to as CDaaS or “Content Delivery as a Service” which will allow not only content delivery, but also growth in the capacities offered today by the CDN infrastructures using “cloud” resources made available to users more or less in real time.

Virtualized content distribution network architectures of this type nevertheless suffer from some disadvantages. A content stored in these networks is generally broken up into a plurality of chunks (“chunk” in English) which are likely to be dispersed over multiple mirror nodes. This dispersion of the chunks of a content results, for example, from user behaviors relating to the proximity of the content or to a content distribution policy of a content provider or a telecommunications operator of the distribution network storing the content. It is, in particular, common for only a part of a content (or, in other words, a set of chunks of the same content which follow one another, for example the first minutes of a video) to be watched. It is noted that the chunks corresponding to a content part of this type are generally stored in mirror nodes located geographically close to the users, while the other parts making up the content remain, for example, in the regional nodes. These other parts are not replicated in the mirror nodes, for example owing to lower demand for these parts. Due to the fluctuating nature of the popularity of a content, relating not only to the parts of the content watched at a given time but also to the geographical areas in which a content or a part of a content is popular at a given time, the dispersion of the chunks of the content may very quickly be expanded. This dispersion of the contents is furthermore accompanied by a reduction in the performance of the network. An increasing number of requests to mirror nodes may, in particular, prove necessary in order to deliver a chunked content. Similarly, a dispersion of the contents is likely to cause a reduction in the quality of the user experience.

One of the objects of the invention is to overcome inadequacies/disadvantages of the prior art and/or make improvements thereto.

According to a first aspect, the invention relates to a method of managing contents in a content distribution network, including physical resources capable of hosting at least one virtualized delivery resource, this method including the following steps, implemented by a content delivery service management entity:
obtaining an audience parameter for a content in at least one of the physical resources capable of hosting a virtualized delivery resource storing at least one chunk of the content;
transmitting an adaptation command for at least one virtualized delivery resource hosted by at least one of the physical resources as a function of the audience parameter.

The method thus allows a reorganization of contents or chunks of a content using a virtualized network infrastructure, also of the “cloud” type. By means of the virtual resources offered by the “cloud” infrastructures, the content chunks are easily redistributed from one virtualized delivery resource to another. The delivery resources designate, more particularly, the mirror nodes to which content storage functions, in particular, are associated, or a content delivery method (e.g. unicast, multicast, streaming).

More particularly, the method enables the organization of the chunks of a content to be adjusted according to an audience parameter relating to the content. By adapting the organization of the chunks of a content as a function of an audience parameter for this content, the quality of the user experience is furthermore increased. The response times for content delivery in response to content requests are reduced.

Similarly, the reorganization of the chunks in the network allows the number of requests for content transfer between nodes of the content distribution network to be reduced. This results in a better utilization of the bandwidth.

According to one particular characteristic, the management method furthermore includes a step of obtaining a distribution of chunks of the content in the content distribution network, the adaptation command depending on the chunk distribution.

The obtaining of a distribution of chunks of the content provides the initial configuration of the chunks of the content, or, in other words, their location in the content distribution network. The search for the chunks of the content, where necessary, is thus simplified. Furthermore, the adaptation of the virtualized delivery resources can thus be operated for only some chunks of the content, rather than for all of the content.

According to one particular characteristic, the audience parameter is obtained from a management entity for the virtualized delivery resources hosted by the physical resources of the network.

The virtualized network function management entity is, for example, an orchestration entity within a “cloud” infrastructure. This entity then manages the lifecycle of the virtualized network functions, the latter comprising the virtualized delivery resources in the context of the invention.

The obtaining of the audience parameter from an entity of this type avoids an interrogation of all of the virtualized delivery resources existing at a given time in the network. An adaptation of the virtualized delivery resources in the network is thus obtained in a more efficient manner. An accelerated reorganization of the content chunks stored, where necessary, by these virtualized delivery resources is also obtained. The centralized management function for the virtualized delivery resources performed by the virtualized network function management entity furthermore provides an audience parameter indicating an overall audience for the content within the network, not limited to a single physical resource of the network.

The obtaining of the audience parameter via an orchestration entity furthermore enables a simplified implementation of the method within the architectures known from the prior art. In particular, no new communication interface is needed to carry out the method.

According to one particular characteristic, the audience parameter is obtained directly from the virtualized delivery resources.

The obtaining of the distribution of the content chunks directly from a delivery resource can be achieved in real time. The reorganization of the content chunks as a function of the audience of the contents is thus speeded up. The processing time for client requests relating to the contents also benefits from the reorganization of the content chunks, this being reflected, in particular, in an increase in the quality of the user experience.

According to one particular characteristic, the audience parameter corresponds to a distribution policy for the content determined by the content provider and/or the content distribution network operator.

The distribution policy provides information relating to the popularity of a known content, for example, of the provider of this content or of the content distribution network operator. This may entail, for example, a popularity determined on the basis of a noted popularity of the content during its distribution in other content distribution networks. The distribution policy may also enable the translation of a policy of a content provider with regard to the distribution of its contents. The adaptation of a virtualized resource may thus advantageously result from a promotion policy for a content in a geographical area in which the physical resource is located. The adaptation may also result from the withdrawal by the content provider itself of a content of which, for example, the popularity is known to be low outside the network.

The method thus allows not only a popularity of the contents measured within the network, but also a popularity of the contents outside the content distribution network to be taken into account. The adaptation of the virtualized resources is refined and allows content-related audience changes to be anticipated.

The distribution policy may also indicate restrictions or conditions to be met (e.g. a maximum number of visualizations, a visualization time period, visualization rights, etc.) in respect of the contents taken into account during the obtaining of the audience parameter. The adaptation of the virtualized resource is thus advantageously differentiated as a function of, for example, a level of service relating to the distribution of a content. Quality of service requirements of a content provider can thus be taken into account during the adaptation. An allocation of delivery resources for a content distribution service of a given content provider may, in particular, be avoided when this provider requires, for example, a low quality of service. Similarly, a content provider requiring a high quality of service will, for example, be given priority when new virtualized delivery resources are offered.

According to one particular characteristic, the transmission of the adaptation command is intended for a management entity for the virtualized delivery resources hosted by the physical resources of the network, the management entity transmitting at least one adaptation command to at least one physical resource hosting a virtualized resource identified in the adaptation command.

The transmission of the adaptation command from one virtualized network function management entity prevents a transmission to all of the virtualized delivery resources existing at a given time in the network. The centralized management function for the virtualized delivery resources performed by the virtualized network function management entity furthermore allows a simultaneous adaptation of all of the virtualized delivery resources hosted by the same physical resource.

As previously indicated, the transmission of the adaptation command via an entity of this type furthermore allows a simplified implementation of the method within architectures known from the prior art. In particular, no new communication interface is needed to carry out the method.

According to one particular characteristic, the audience parameter relates to a number of accesses to the content, the adaptation of a virtualized resource including the storage by a virtualized resource of a set of chunks of the content when the audience parameter indicates a number of accesses to the content greater than a popularity threshold.

The method thus allows the chunks of a content to be grouped together when a content is identified as popular (audience parameter indicating a large audience). The use of virtualized delivery resources is optimized as a function of the audience indicated by the audience parameter.

According to one particular characteristic, when one chunk from the set of chunks of the content is stored by another virtualized delivery resource, the adaptation includes the deletion of said chunk from the other virtualized delivery resource.

The method thus allows storage resources to be freed up by deleting redundant chunks of the same content.

According to one particular characteristic, the adaptation command identifying a physical resource not hosting a virtualized resource storing a chunk of the content, the adaptation of the virtualized resource furthermore includes the creation of a virtualized resource hosted by the physical resource, the virtualized resource storing all of the chunks of said content.

The method thus allows the grouping together of a set of the chunks of a content which is popular in regions where it is not yet stored. This is the case, in particular, when it is anticipated that a content will become popular in a given region.

According to one particular characteristic, the audience parameter relates to a number of accesses to the content, the adaptation of the virtualized resource consisting in the deletion of the chunks of the content stored on the virtualized resource when the audience parameter indicates a number of accesses to the content below an unpopularity threshold.

A decline in popularity may thus be taken into account in assigning the virtualized delivery resources made available, for example, to a particular content provider. The deletion of a virtualized delivery resource allows resources of the content distribution network to be freed up. The resources of the distribution network are thus used in an optimized manner as a function of the change in popularity of the contents.

According to a second aspect, the invention relates to a content delivery service management entity in a content distribution network, including physical resources capable of hosting at least one virtualized delivery resource. The entity includes:
a first transceiver module, configured to obtain an audience parameter for a content in one of the physical resources capable of hosting a virtualized delivery resource storing at least one chunk of the content;
a computing module, configured to generate an adaptation command for at least one virtualized delivery resource hosted by at least one of the physical resources as a function of the audience parameter;
a first transmission module, configured to transmit the adaptation command for at least one virtualized delivery resource hosted by at least one of the physical resources as a function of the audience parameter.

According to one particular characteristic, the content delivery service management entity furthermore includes a second transceiver module, configured to obtain a distribution of chunks of a content in the content distribution network. The computing module is then configured to generate the adaptation command for at least one virtualized delivery resource hosted by at least one of the physical resources as a function of the audience parameter and the chunk distribution.

The advantages specified for any one of the characteristics of the management method according to the first aspect are directly transposable to the content delivery service management entity according to the second aspect.

According to a third aspect, the invention proposes a content management system in a content distribution network, including physical resources capable of hosting at least one virtualized delivery resource. The system includes:
a content delivery service management entity according to the second aspect;
a management entity for the virtualized delivery resources hosted by the physical resources of the network, including a transceiver module, configured to send an audience parameter to the content delivery service management entity and to receive an adaptation command for at least one virtualized delivery resource hosted by at least one of the physical resources.

According to a fourth aspect, the invention also relates to a program for a content delivery service management entity, including program code instructions intended to control the performance of the steps of the previously described method, when said program is executed by said entity, and a recording medium which is readable by a content delivery service management entity and on which a program of this type is recorded.

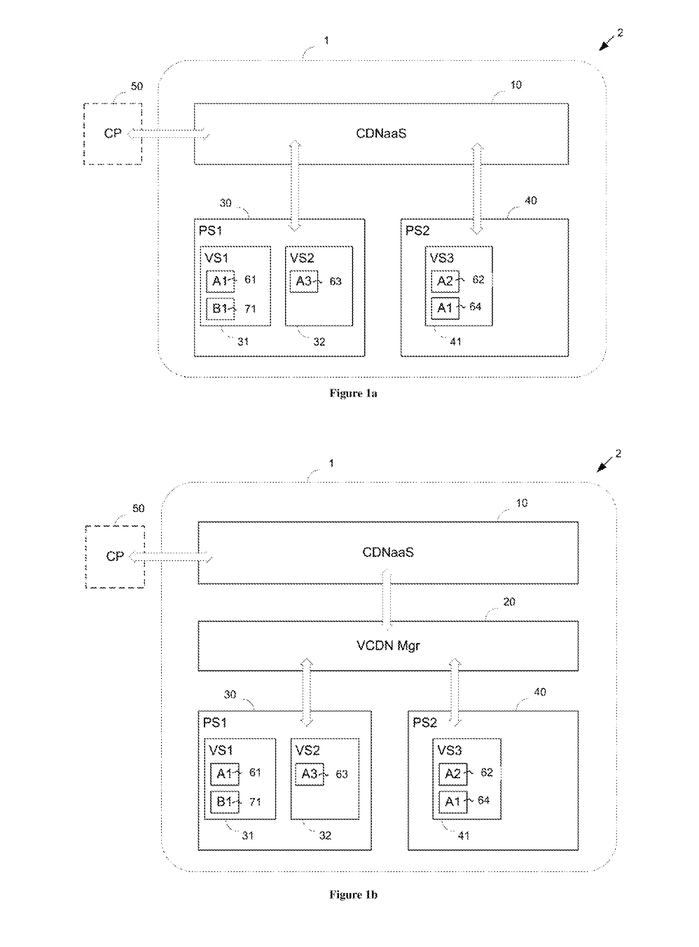

The invention will be better understood from the following description of particular embodiments, with reference to the attached drawings in which:
FIGS. 1a and 1b show a content management system according to two embodiments;

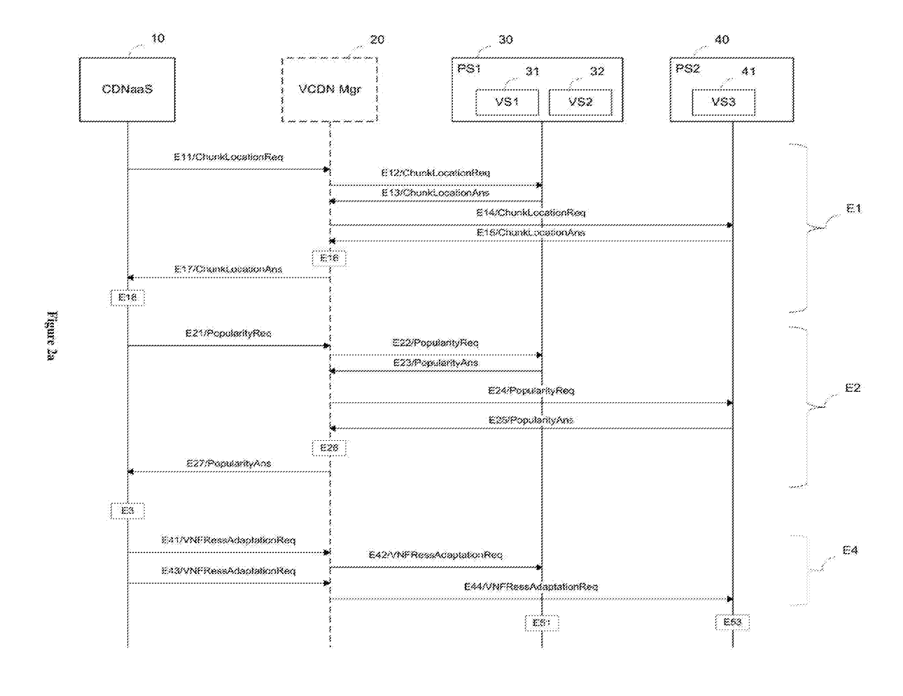

FIGS. 2a and 2b show steps of a management method according to two particular embodiments;

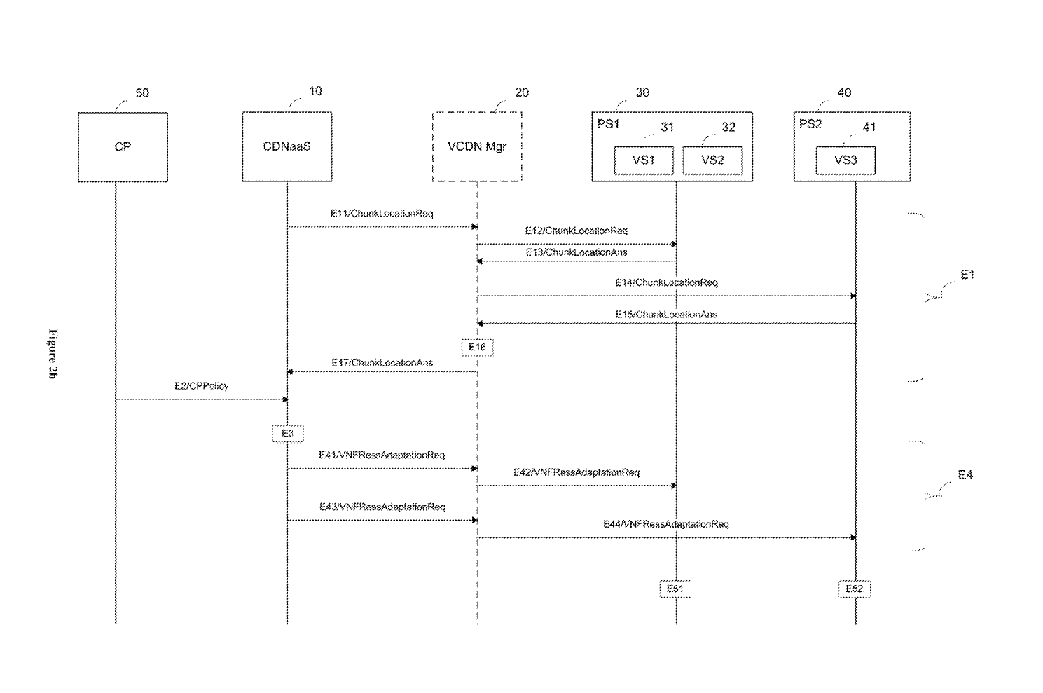

FIG. 3 shows steps of a management method for generating an adaptation command according to one particular embodiment;

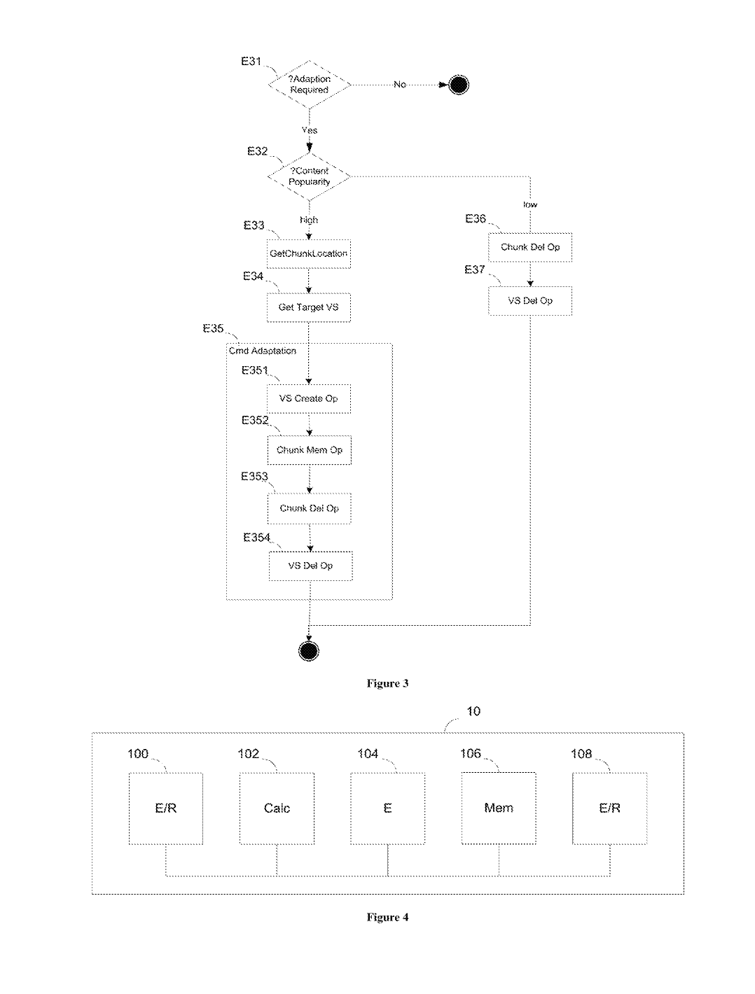

FIG. 4 shows a content delivery service management entity according to one particular embodiment.

FIGS. 1a and 1b show a system 1 for managing contents in a content distribution network 2 according to two different embodiments. The system I proposes, more particularly, an infrastructure as a service, providing a content delivery service, implemented by a set of virtualized delivery resources 31, 32 and 41.

In a first embodiment described in relation to FIG. 1a, the system 1 comprises only a delivery service management entity 10 and physical resources 30 and 40 capable of hosting the virtualized delivery resources 31, 32 and 41.

The physical resources 30 and 40 serve client entities requiring a content when these client entities are located in a region served by one of these physical resources 30 and 40 (typically the region where the physical resource concerned is located) in the content distribution network 2. The physical resources make up the mirror nodes of the content distribution network 2. In the embodiment described in relation to FIG. 1a, the physical resource 30 hosts the two virtualized delivery resources 31 and 32. The physical resource 40 hosts a single virtualized resource 41.

The virtualized delivery resources 31, 32 and 41 implement virtualized network functions (in English VNF for Virtual Network Functions) as defined in the FBI specification document “GS NFV 003 v1,1.1”, dated October 2013. These virtualized network functions are, more particularly, virtualized network functions for content delivery. Each of these virtualized delivery resources 31, 32 and 41 can store at least one content chunk. By way of example, the virtualized resource 31 stores a chunk A1 61 of a content A and a chunk B1 71 of a content B, the virtualized resource 32 stores a chunk A3 63 of the content A, and the virtualized resource 41 stores the chunks A2 62 and A1 64 of the content A.

The physical resources 30 and 40, and also the virtualized delivery resources 31, 32 and 41 are, for example, assigned to a third party 50 using the services provided by the system 1. This third party 50 is, by way of example, a content provider or a communication network operator. In another embodiment, both the physical and virtual resources may also be assigned to a plurality of third parties, in which case each resource is either a resource dedicated to a given third party or a resource shared among a plurality of third parties.

The content delivery service management entity 10 is responsible for the deployment and management of the virtualized delivery resources 31, 32 and 41. This entity 10 is, for example, a content distribution network controller. In particular, it allows the virtualized content delivery resources 31, 32 and 41 to be adapted as a function of an audience parameter (this will be described in detail below in relation to the management method). This adaptation is implemented, where necessary, according to the third party/parties to which virtualized resources have been allocated. In particular, the entity 10 instructs its underlying virtual network infrastructure to carry out the virtual resource adaptations necessary for the provision of an optimized delivery service. To do this, the entity 10 communicates directly with the physical resources 30 and 40 of the content distribution network 2 and may thus directly access the virtualized delivery resources 31, 32 and 41.

In a further different embodiment, the content delivery service management entity 10 also communicates with a third party 50 (e.g. a content provider). In particular, this allows the content delivery service management entity 10 to take account of a content distribution policy when it performs its function of adapting the virtualized delivery resources 31, 32 and 41.

FIG. 1b shows a second embodiment of the content management system 1. In this second embodiment, the content management system 1 includes, in addition to the content delivery service management entity 10 and the physical resources 30 and 40 capable of hosting the virtualized delivery resources 31, 32 and 41, a virtualized delivery resource management entity 20. This latter entity 20 forms part of the virtual network infrastructure of which the delivery service management entity 10 uses the services. In this second embodiment, in order to manage the virtualized delivery resources 31, 32 and 41 hosted by the physical resources 30 and 40, the management entity 10 does not communicate directly with the physical resources 30 and 40, but with the virtualized delivery resource management entity 20.

The entity 20 provides information in a centralized manner relating to the set of virtualized delivery resources 31, 32 and 41, and transmits them to the content delivery service management entity 10. This virtualized delivery resource management entity is, for example, an orchestration entity (in English orchestrator) or a virtualized network function manager (in English VNF Manager). In particular, the virtualized delivery resource management entity 20 prevents a systematic interrogation of all the virtualized delivery resources existing at a given time in the network. The virtualized delivery resource management entity 20 furthermore correlates the information obtained from the virtualized delivery resources 31, 32 and 41 before transmitting them to the content delivery service management entity 10.

It should furthermore be noted that the embodiments described in relation to FIGS. 1a and 1b are simplified representations of the system 1 aimed at facilitating the understanding thereof. No limitation is imposed on the number of physical resources 30 and 40. Similarly, no limitation is imposed on the number of virtualized delivery resources 31, 32 and 41 hosted by the physical resources 30 and 40. Conversely, one virtualized delivery resource may also be distributed among a plurality of physical resources, in which case there is also no limitation imposed on the number of physical resources supporting this virtualized delivery resource. The number of content chunks stored by a virtualized resource is for its part limited only by the storage capacities associated with this resource.

FIGS. 2a and 2b describe the steps of a management method according to two particular embodiments. These two embodiments differ in terms of the manner in which they obtain an audience parameter. In the first embodiment described in relation to FIG. 2a, the audience parameter is obtained from the physical resources 30 and 40. In the second embodiment described in relation to FIG. 2b, the audience parameter is obtained from a content provider 50.

The first embodiment will now be described in relation to FIG. 2a. By way of illustration, a content A and a content B are considered which are stored in physical resources 30 and 40, as previously described in relation to FIG. 1b, i.e. of which the chunk A1 is stored by the virtualized delivery resources 31 and 41, the chunk A2 is stored only by the virtualized delivery resource 41, the chunk A3 is stored only by the virtualized delivery resource 32, and the chunk B1 is stored only by the virtualized delivery resource 31.

In a step E1, the content delivery service management entity 10 obtains from the physical resources 30 and 40 a distribution of the content chunks in the content distribution network 2. The distribution of the content chunks is, for example, a list L1 of identifiers of the content chunks respectively associated with at least one pair made up of an identifier of a virtualized resource storing the chunk and an identifier of the physical resource hosting the virtualized resource. This step provides a mapping of the content chunks stored in the content distribution network 2.

Step E1 is, more particularly, made up of sub-steps E11-E18.

In sub-step E11, the content delivery service management entity 10 sends a request to obtain a distribution of the content chunks in the content distribution network 2 to a virtualized delivery resource management entity 20. The virtualized resource management entity 20 is, by way of example, a device orchestrating a virtual network infrastructure, including the virtualized resources 31, 32 and 41 hosted by the physical resources 30 and 40.

The virtualized delivery resource management entity 20 then transfers the request to obtain a distribution to all of the physical resources 30 and 40 of the content distribution network 2.

More precisely, in sub-step E12, the virtualized delivery resource management entity 20 transfers the distribution request to the physical resource 30. The latter hosts the virtualized delivery resources VS1 31 and VS2 32 which respectively store the chunks A1 61 and B1 71, and A3 63 of the contents A and B.

In sub-step E13, the physical resource 30 returns to the virtualized delivery resource management entity 20, in response to the request, a list of three pairs (A1; (VS PS1)) (B1; (VS1; PS1)) and (A3; (VS2; PS1)) associating the identifiers of the chunks A1, B1, and A3 with the identifiers of the physical resource PS1 and the virtualized delivery resource VS1 storing these chunks. The pair (A1; (VS1; PS1)) thus indicates that the chunk A1 61 is stored by the virtualized delivery resource VS1 31 hosted by the physical resource PS1 30. The pair (B1; (VS1; PS1)) indicates that the chunk B1 71 is stored by the virtualized delivery resource VS1 31 hosted by the physical resource PS1 30. Similarly, the pair (A3; (VS2; PS1)) indicates that the chunk A3 63 is stored by the virtualized delivery resource VS2 32 hosted by the physical resource PS1 30.

In sub-step E14, as previously described for sub-step E12, the virtualized delivery resource management entity 20 transfers the request to obtain a distribution to the physical resource 40. The latter hosts a delivery resource VS3 41 which stores two chunks A1 64 and A2 62 of the content A.

In sub-step E15, as previously described for sub-step E13, the physical resource 40 returns to the virtualized delivery resource management entity 20, in response to the request, a list of two pairs (A1; (VS3; PS2)) and (A2; (VS3; PS2)). The pair (A1; (VS3; PS2)) indicates that the chunk A1 64 is stored by the virtualized delivery resource VS3 41 hosted by the physical resource PS2 40. Similarly, the pair (A2; (VS3; PS2)) indicates that the chunk A2 62 is stored by the virtualized delivery resource VS3 41 hosted by the physical resource PS2 40.

In sub-step E16, the virtualized delivery resource management entity 20 aggregates the content chunk distribution information obtained from the physical resources 30 and 40 in order to draw up the list L1 describing the distribution of the content chunks in the content distribution network 2. The list L1 thus indicates the location of the chunks of the content A and of the content B in the content distribution network 2 and may assume the following form:

A1; (VS1, PS1); (VS3, PS2)
A2; (VS3, PS2)
A3; (VS2, PS1)
B1; (VS1, PS1)

In sub-step E17, the virtualized delivery resource management entity 20 then transmits the content chunk distribution (i.e. the list L1) to the content delivery service management entity 10 which can then store this list L1.

This list L1 is then updated by identifying the contents to which the chunks indicated in the list L1 belong and by associating a content identifier with the identifiers of chunks in the list L1.

To do this, in a content identification sub-step E18, the content delivery service management entity 10 sends a request, including the identifiers of chunks of the chunk distribution to a device of the content distribution network 2 enabling identification of the contents to which these chunks belong. This device is, for example, a database server managed by the operator of the content distribution network 2 or by a third-party partner of the operator, storing the list of chunk identifiers associated with a content identifier. At the end of this sub-step, each chunk is thus associated with the content to which it belongs, and its location(s) in the content distribution network is/are identified. The list L1 is updated in order to reflect this association:

| | |
|---|---|
| A | A1; (VS1, PS1); (VS3, PS2) |
| A | A2; (VS3, PS2) |
| A | A3; (VS2, PS1) |
| B | B1; (VS1, PS1) |

Alternatively, this content identification sub-step E18 can be carried out by the virtualized delivery resource management entity 20 which is responsible for updating the list L1 with the identifiers of the contents A, B obtained from the device enabling identification of the contents to which the chunks belong, before transmitting this updated list to the content delivery service management entity 10.

In a step E2, the content delivery service management entity 10 obtains an audience parameter for the content A from the physical resources 30 arid 40. The audience parameter is, by way of example, a number of requests to access the content A associated with each physical resource 30 and 40. The number of access requests is, for example, incremented on reception by a physical resource of a request received from a client entity to access one of the chunks of the content A. The number of requests to access the content A for the physical resource 30 (and for the physical resource 40 respectively) thus indicates a level of popularity of this content A in the region served by this physical resource 30 (and by the physical resource 40 respectively), i.e. in the region corresponding to the location of this physical resource 30 in the content distribution network 2.

The step E2 includes, more particularly, a set of sub-steps E21-E27.

In sub-step E21, the content delivery service management entity 10 transmits a request to a virtualized delivery resource management entity 20 to obtain an audience parameter for the content A in the content distribution network 2.

The virtualized delivery resource management entity 20 then transfers this request to the physical resources 30 and 40 in order to obtain the audience parameter for the content A.

More precisely, in sub-step E22, the virtualized delivery resource management entity 20 transfers the request to obtain the audience parameter for the content A to the physical resource 30.

In sub-step E23, the physical resource 30 returns the number of requests which it has received to access the content A to the virtualized delivery resource management entity 20 in response to this request. By way of example, the physical resource 30 sends an audience parameter pa1=105,000 to the virtualized delivery resource management entity 20, indicating that the content A has been requested 105,000 times from the resource 30.

In sub-step E24, as previously described for sub-step E22, the virtualized delivery resource management entity 20 transfers the request to obtain the audience parameter for the content A to the physical resource 40.

In sub-step E25, as previously described for sub-step E23, the physical resource 40 returns the number of requests which it has received to access the content A to the virtualized delivery resource management entity 20 in response to this request. By way of example, the physical resource 40 sends an audience parameter pa2=100 to the virtualized delivery resource management entity 20, indicating that the content A has been requested 100 times from the resource 40.

In sub-step E26, the virtualized delivery resource management entity 20 collects the information relating to the audience of the content A obtained from the physical resources 30 and 40 in order to draw up a list L2 which may assume, by way of example, the following form:

L2={(PS1, 105,000; (PS2, 100)}

The pairs (PS1, 105,000) and (PS2, 100) indicate that the content A has been accessed 105,000 times in the physical resource PS1 30, and 100 times in the physical resource PS2 40 respectively.

In sub-step E27, this list L2 is sent by the virtualized delivery resource management entity 20 to the content delivery service management entity 10.

This last sub-step E27 ends step E2 of the management method. The content delivery service management entity 10 then stores two lists L1 and L2, corresponding to a distribution of the content A in the content distribution network 2 and to an audience parameter for this content A measured in the physical resources 30 and 40 respectively.

In a step E3, the content delivery service management entity 10 determines and generates, where necessary, as a function, in particular, of the audience parameter obtained during step E2, adaptation commands for virtualized delivery resources hosted by the physical resources 30 and 40 respectively. The steps of generating an adaptation command will be described in detail below in relation to FIG. 3.

By way of example, it is assumed in the present embodiment that two adaptation commands are generated: a command C1 to adapt the virtualized delivery resources hosted by the physical resource PS1 30, for the content A determined as being popular in this physical resource PS1 30, and a command C2 to adapt the virtualized delivery resources hosted by the physical resource PS2 40, for the content A determined as being unpopular in this physical resource PS2 40.

In a step E4, the delivery service management entity 10 transmits an adaptation command for the virtualized delivery resources hosted by the physical resources of the content distribution network 2. This step E4 is, more particularly, made up of sub-steps E41-E44.

In sub-step E41 (and E43 respectively), the content delivery service management entity 10 transmits the adaptation command C1 (and C2 respectively) to the virtualized delivery resource management entity 20.

Then, in sub-step E42 (and E44 respectively), the virtualized delivery resource management entity 20 then transmits this adaptation command C1 (and C2 respectively) to the physical resource PS1 30 (and PS2 40 respectively).

In a step E51, the virtualized delivery resources 31 and 32 hosted by the physical resource PS1 30 are adapted in accordance with the adaptation command C1 by applying one or more operations included in this command C1, as illustrated below. By way of example, at the end of this adaptation, the virtualized delivery resource VS2 32 is deleted and the virtualized delivery resource VS1 31 stores the content chunks A1 61, A2 62, A3 63 and B1 71.

Similarly, in a step E52, the virtualized delivery resource 41 hosted by the physical resource PS2 40 is adapted in accordance with the adaptation command C2 by applying one or more operations included in this command C2, as illustrated below. By way of example, at the end of this adaptation, the virtualized delivery resource VS3 41 is deleted.

This last step brings the management method to an end.

It should be noted that the method does not impose any order with regard to the performance of the steps E1 and E2 which precede step E3.

In another embodiment, the audience parameter is broken down by virtualized delivery resource. This then involves a number of accesses to a content for a particular virtualized resource hosted by a given physical resource. In this embodiment, in sub-step E23, the physical resource 30 returns the number of requests which it has received to access the content A for each virtualized delivery resource 31 and 32 which it hosts in response to the virtualized delivery resource management entity 20. By way of example, the physical resource 30 sends an audience parameter pa11=105,000 to the virtualized delivery resource management entity 20, indicating that the content A has been accessed 105,000 times in the virtualized delivery resource 31, and an audience parameter pa11=104,000, indicating that the content A has been accessed 104,000 times in the virtualized delivery resource 32. Similarly, in sub-step E25, the physical resource 40 returns, by way of example, an audience parameter pa21 =100 to the virtualized delivery resource management entity 20, indicating that the content A has been accessed 100 times in the virtualized delivery resource 41. The list L2 obtained in sub-step E26 assumes, by way of example, the following form:

L2={(VS1, PS1, 105,000); (VS2, PS1, 104,000); (VS3, PS2, 100)}

The pairs (VS1, PS1, 105,000), (VS2, PS1, 104,000) and (VS3, PS2, 100) indicate that the content A has been accessed 105,000 times in the virtualized delivery resource VS1 31 hosted by the physical resource PS1 30, 104,000 times in the virtualized delivery resource VS2 32 hosted by the physical resource PS1 30, and 100 times in the virtualized delivery resource VS3 41 hosted by the physical resource PS2 40 respectively. A more precise criterion for the triggering of an adaptation of the virtualized resources of a physical resource is thus possible.

In another embodiment, the distribution of chunks and the audience parameter for the content A are obtained in the same step. The sub-steps E11 and E21 (and E12 and E22, and also E14 and E24 respectively) are then combined in a step comprising the transmission of a single request to obtain the distribution and the audience parameter. The same applies to the response sub-steps E17 and E27 (and E13 and E23, and also E15 and E25 respectively) in which the infomiation relating to the distribution of chunks of the content A is returned at the same time as the audience parameter for the content A. Similarly, the sub-steps E16 and E26 are implemented in the same single step providing a list L comprising the information relating to both the chunk distribution and the audience for the content A. By way of example, in this embodiment, the list L may assume the following form:

| | |
|---|---|
| A | A1; (VS1, PS1, 105,000); (VS3, PS2, 10) |
| A | A2; (VS3, PS2, 10) |
| A | A3; (VS2, PS1, 105,000) |

It will be noted that, in this embodiment also, the number of accesses may easily be broken down by virtualized delivery resource or by physical resource.

In another embodiment corresponding to FIG. 1a, the method does not implement the virtualized delivery resource management entity 20. The requests transmitted by the delivery service management entity 10 are then sent directly to the physical resources 30 and 40. The latter similarly respond directly to the delivery service management entity 10. The method may thus be advantageously implemented with an existing virtual network infrastructure without the need for a specific orchestration device.

In another further embodiment, the virtualized delivery resource management entity 20 is implemented for only one or more steps out of the steps of obtaining a distribution of chunks of a content, obtaining an audience parameter for a content or transmitting an adaptation command for virtualized delivery resources. The other steps are then performed through direct interrogation of the physical resources 30 and 40 by the delivery service management entity 10. This direct interrogation of the physical resources provides, in particular, content distribution information in real time. The orchestration device 20 is furthermore not systematically involved in all of the steps of the method, thereby allowing the computing resources of the orchestration device thus freed up to be assigned to other processing operations.

In another embodiment, the sub-step E16 of aggregating the information relating to the distribution of chunks of the content A is implemented by the content delivery service management entity 10. This is the case, in particular, when the content delivery service management entity 10 sends the request to obtain the distribution of the content A directly to the physical resources 30 and 40. The latter then respond directly to the management entity 10 by transmitting to it their respective information relating to the distribution of chunks of the content A.

FIG. 2b describes the steps of a management method according to one particular embodiment in which the audience parameter is obtained from a content provider 50.

In this embodiment, the step E2 of obtaining an audience parameter does not comprise the previously described sub-steps E21-E27, but a step E2 of transmitting, from the content provider 50 to the management entity 10, an audience parameter corresponding to a distribution policy for the contents provided by the content provider 50. This distribution policy indicates, for example, a number of accesses estimated or desired by the content provider for a given content A in the physical resources of the content distribution network 2. As previously described in relation to FIG. 2a, the audience parameter may, in this embodiment also, be broken down by physical resource or by virtualized delivery resource. It is thus advantageously possible to promote a content in a region adjacent to the location of a physical resource, or to take account of changes in the popularity of a content outside the content distribution network 2.

The other steps are identical to those described in relation to FIG. 2a.

FIG. 3 shows steps of the management method relating to the generation of an adaptation command according to one particular embodiment. By way of illustration, a content A stored in physical resources 30 and 40, as previously described in relation to FIG. 1a or 1b is considered here. The steps relating to the generation of an adaptation command are furthermore implemented by a content delivery service management entity 10, as described in relation to FIG. 1b. This content delivery service management entity 10 furthermore stores a distribution of chunks L1 of the content A, and also audience information in the form of a list L2 of the content A, broken down by physical resource, as previously described in relation to FIG. 2a.

In a step E31, the content delivery service management entity 10 checks, using the list L2, whether or not there is a need to trigger an adaptation of the virtualized delivery resources for the content A. More precisely, the adaptation of the virtualized delivery resources is triggered as a function of the audience parameters for the content A in the physical resources 30 and 40, as supplied in the list L2.

In a first case, the adaptation of the virtualized delivery resources is triggered as soon as a content A is deemed to be “popular” in a physical resource, i.e. as soon as the audience parameter for the content A for a physical resource exceeds a predefined popularity threshold S1. By way of example, this threshold S1 is set at 100,000 accesses.

In another case, the adaptation of the virtualized delivery resources is triggered as soon as a content A is deemed to be “unpopular” in a physical resource, i.e. as soon as the audience parameter for the content A for a physical resource is below a predefined unpopularity threshold S2. By way of example, this threshold S2 is set at 200.

Thus, when the number of accesses measured for the content A in a physical resource is above the popularity threshold S1, or as soon as it is below the unpopularity threshold S2, the content delivery service management entity 10 triggers a corresponding adaptation of the virtualized resources hosted by this physical resource. When the number of accesses measured in a physical resource for a content is between the thresholds S1 and S2, no adaptation of the virtualized delivery resources is triggered.

In the example considered here, the list L2 indicates, in particular, that the content A is popular in the physical resource PS1 30 (number of accesses=105,000>S1), but that it is, on the other hand, unpopular in the physical resource PS2 40 (number of accesses=100<S2).

In a step E32 of determining an adaptation command for the virtualized delivery resources, the content delivery service management entity 10 determines whether the adaptation command for the virtualized delivery resources of the physical resource concerned relates to a popular content or an unpopular content. Two situations are to be distinguished: adaptation command for a popular content (as in the case of the content A in the physical resource PS1 30) and adaptation command for an unpopular content (as in the case of the content A in the physical resource PS2 40).

In the first case of an adaptation command C1 for a content which is popular in a physical resource, the adaptation consists in grouping together all of the chunks of this content stored by the virtualized delivery resources of the network on the same virtualized delivery resource hosted by this physical resource. The adaptation of the content A, popular in the physical resource PS1 30, consists therefore in grouping together all of the chunks 61-64 on the same virtualized delivery resource hosted by the physical resource PS1 30. To do this, in a step E33, the content delivery service management entity 10, using the distribution of chunks of the content A (list L1 obtained in step E2), determines which virtualized delivery resources store chunks of the content A. The distribution of chunks of the content A indicates, in particular, that a chunk A1 61 is stored by the virtualized delivery resource VS1 31 hosted by the physical resource PS1 30, that a second chunk A1 64 is stored by the virtualized delivery resource VS3 41 hosted by the physical resource PS2 40, that a chunk A2 62 is stored by the virtualized delivery resource VS3 41 hosted by the physical resource PS2 40, and a chunk A3 63 is stored by the virtualized delivery resource VS2 32 hosted by the physical resource PS1 30.

In a step E34, the content delivery service management entity 10, using the distribution of chunks of the content A, determines which virtualized resource hosted by the physical resource PS1 30 stores the most chunks of the content A. When a plurality of virtualized resources store the same number of chunks of the content A, a target virtualized resource is selected randomly from them. This target virtualized resource is intended to host all of the chunks of the content A located in the distribution network 2 using the distribution of chunks of the content A. In the example considered, the physical resource PS1 30 hosting two virtualized resources 31 and 32, each storing a chunk of the content A, the first virtualized resource VS1 31 is selected in a random manner.

In a step E35, the content delivery service management entity 10 determines the adaptation operations to be carried out in the physical resource. These operations consist in one of the following four elementary operations: deletion of one or more chunks of a content stored by a virtualized delivery resource, storing of one or more chunks of a content by a virtualized delivery resource, deletion of a virtualized delivery resource, creation of a virtualized delivery resource, or the combination of one or more of these elementary operations. Here, the adaptation operations concern the physical resource PS1 30 and form an adaptation command which will then be transmitted to the virtualized delivery resource management entity 20. The adaptation operations are furthermore intended to be carried out sequentially in the order in which they are added to the adaptation command generated in step E35.

Step E35 includes a set of sub-steps E351-E354.

In sub-step E351, the content delivery service management entity 10 determines whether a new virtualized delivery resource must be created and whether it is appropriate to include a creation operation of this type in the adaptation command currently being generated. An operation of this type is to be carried out when the physical resource to which the adaptation command for the virtualized delivery resources applies does not host any virtualized delivery resource storing any chunk of the content concerned. In the example considered here, the physical resource PS1 30, including two virtualized delivery resources, each storing a chunk of the content A, no operation to create a virtualized delivery resource is added to the adaptation command currently being generated in this sub-step 351.

In a sub-step E352, the content delivery service management entity 10 determines whether it is appropriate to include an operation to store a chunk in the adaptation command currently being generated. Only the chunks of the content not present on the target virtualized resource determined in step E34 are to be stored on this target virtualized resource, these chunks which are not present being identified using the distribution of chunks of the content concerned. In the example considered here, relating to the content A which is popular in the physical resource PS1 30, two adaptation operations are thus added to the adaptation command currently being generated: storage of the chunk A2 62 by the virtualized resource VS1 31 from the virtualized resource VS3 41, and storage of the chunk A3 63 by the virtualized resource VS1 31 from the virtualized resource VS2 32.

In a sub-step E353, the content delivery service management entity 10 determines whether it is appropriate to include an operation to delete a chunk from the adaptation command currently being generated. In particular, all the chunks of the content A stored by a virtualized resource hosted by the physical resource PS1 30 other than the target virtualized resource VS1 30 are to be deleted. In particular, this prevents the same chunk from being stored unnecessarily by a plurality of virtualized delivery resources hosted by the same physical resource. The chunks to be deleted are identified using the distribution of chunks of the content concerned. In the example considered here, a deletion operation is then added to the adaptation command currently being generated: deletion of the chunk A3 63 of the virtualized resource VS2 32. The virtualized resource VS2 32 will then no longer store any chunk following the reception of the adaptation command.

Finally, in a sub-step E354, the content delivery service management entity 10 determines whether it is appropriate to include in the adaptation command currently being generated an operation to delete the virtualized delivery resources hosted by the physical resource PS1 30 no longer storing any chunk (of any content) or intended to no longer store any chunk following possible chunk deletion operations included in the adaptation command currently being generated. In the example considered here, an operation to delete the virtualized delivery resource VS2 32 is added to the adaptation command, since this virtualized resource will no longer store any chunk following the deletion of the chunk A3 63 decided in sub-step 353.

This last sub-step ends the generation of the adaptation command C1 for the virtualized delivery resources hosted by the physical resource PS1 30. This adaptation command C1 can then be transmitted from the management entity 10 to the physical resource 30, possibly via the entity 20, so that this physical resource 30 implements the different operations provided in this command in order to perform the adaptation of the virtualized resources which it hosts, as shown in FIG. 2a or 2b.

In the second case of an adaptation command C2 for a content which is unpopular in a physical resource, the adaptation consists in deleting all the chunks of this content stored by virtualized delivery resources hosted by this physical resource. In the example considered here, the adaptation of the virtualized resources for the content A, unpopular in the physical resource PS2 40, therefore consists in deleting the chunks A1 62 and A2 64 of the content A stored by the virtualized delivery resource 41. To do this, in a step E36, two operations of deleting a chunk for the chunks A2 62 and A1 64 respectively, stored by the virtualized delivery resource 41, are added to the adaptation command C2 currently being generated.

Then, in a step E37, the virtualized resources no longer storing content chunks or intended to no longer store them following the possible chunk deletion operations included in the adaptation command currently being generated are identified in order to be deleted if necessary. In the example considered, insofar as the virtualized delivery resource 41 will no longer store any chunk following the deletion of chunks A2 62 and A1 64, this results in the addition to the adaptation command C2 intended for the physical resource PS2 40 of an operation to delete the virtualized delivery resource VS3 41.

The generation of the adaptation command C2 for the virtualized delivery resources hosted by the physical resource PS2 40 for a content A which is unpopular in this physical resource is then ended.

In another embodiment, in the step E31 of determining the triggering of an adaptation of the virtualized delivery resources, a single popularity threshold can be defined and used. In an embodiment of this type, a content being considered to be either popular or unpopular, the adaptation of the virtualized delivery resources is systematically triggered. The virtualized delivery resources are thus adapted continuously as a function of changes in the popularity of the contents.

FIG. 4 shows a content delivery service management entity 10 in a content distribution network, including physical resources capable of hosting at least one virtualized delivery resource. It includes, in particular:
a first transceiver module 100, configured to obtain an audience parameter for a content in at least one of the physical resources capable of hosting a virtualized delivery resource storing at least one chunk of the content;
a computing module 102, configured to generate an adaptation command for at least one virtualized delivery resource hosted by at least one of the physical resources as a function of the audience parameter;
a transmission module 104, configured to transmit the adaptation command for at least one virtualized delivery resource hosted by at least one of the physical resources as a function of the audience parameter to the physical resource concerned.

The content delivery service management entity 10 furthermore includes a physical memory 106, configured to store the audience parameter and the adaptation command.

In one particular embodiment, the content delivery service management entity 10 furthermore includes a second transceiver module 108, configured to obtain a distribution of chunks of a content in the content distribution network. The computing module 102 is then configured to generate the adaptation command for at least one virtualized delivery resource hosted by at least one of the physical resources as a function of the audience parameter and the chunk distribution.

The invention is implemented by means of software and/or hardware components. In this respect, the term “module” may correspond in this document not only to a software component, but also to a hardware component or to a set of hardware and/or software components capable of implementing a function or a set of functions, according to the description given above for the module concerned.

A software component corresponds to one or more computer programs, one or more subprograms of a program or, in a more general manner, to any element of a program or software. A software component of this type is stored in a memory then loaded and executed by a data processor of a physical entity, and is likely to access the hardware resources of this physical entity (memories, recording media, communication buses, electronic input/output cards, user interfaces, etc.).

Similarly, a hardware component corresponds to any element of a hardware assembly. It may be a programmable or non-programmable hardware component, with or without an integrated processor to run the software. It is, for example, an integrated circuit, a chip card or an electronic card to run microsoftware (firmware), etc.

In one particular embodiment, the modules 100, 102, 104, 106 and 108 are configured to carry out the previously described management method. They are preferably software modules, including software instructions to initiate the performance of those of the steps of the previously described management method implemented by a content delivery service management entity. The invention therefore also relates to:
a program for a content delivery service management entity, including program code instructions intended to control the performance of the steps of the previously described management method when said program is executed by said one content delivery service management entity
a recording medium readable by a content delivery service management entity on which the program for a content delivery service management entity is recorded.

The software modules may be stored in or transmitted by a data medium. The latter may be a hardware storage medium, for example a CD-ROM, a magnetic diskette or a hard disk, or a transmission medium such as an electrical, optical or radio signal, or a telecommunication network.

1. A method of managing contents in a content distribution network (2), including physical resources (30, 40) capable of hosting at least one virtualized delivery resource (31, 32, 41), said method including the following steps, implemented by a content delivery service management entity (10):
obtaining (E2) an audience parameter for a content in at least one of said physical resources capable of hosting a virtualized delivery resource storing at least one chunk (61-64, 71) of said content;
transmitting (E4) an adaptation command for at least one virtualized delivery resource hosted by at least one of said physical resources as a function of said audience parameter.

2. The management method as claimed in claim 1, furthermore including a step of obtaining (E1) a distribution of content chunks in said content distribution network, the adaptation command depending on said chunk distribution.

3. The management method as claimed in claim 1, in which the audience parameter is obtained from a management entity for the virtualized delivery resources (20) hosted by the physical resources of the network.

4. The management method as claimed in claim 1, in which the audience parameter is obtained directly from the virtualized delivery resources.

5. The management method as claimed in claim 1, in which the audience parameter corresponds to a distribution policy for said content determined by the content provider and/or the content distribution network operator.

6. The management method as claimed in claim 1, in which the transmission of said adaptation command is intended for a management entity (20) for the virtualized delivery resources hosted by the physical resources of the network, said management entity (20) transmitting (E42, E44) at least one adaptation command to said at least one physical resource hosting a virtualized resource identified in the adaptation command.

7. The management method as claimed in claim 1, in which the audience parameter relates to a number of accesses to said content, the adaptation of said at least one virtualized resource including the storage by a virtualized resource of a set of chunks of said content when said audience parameter indicates a number of accesses to said content greater than a popularity threshold.

8. The management method as claimed in claim 7, in which, when one chunk from said set of chunks of the content is stored by another virtualized delivery resource, the adaptation includes the deletion of said chunk from the other virtualized delivery resource.

9. The management method as claimed in claim 8, in which, the adaptation command identifying a physical resource not hosting a virtualized resource storing a chunk of the content, the adaptation of said virtualized resource furthermore includes the creation of a virtualized resource hosted by said physical resource, said virtualized resource storing all of the chunks of said content.

10. The management method as claimed in claim 1, in which the audience parameter relates to a number of accesses to said content, the adaptation of said virtualized resource consisting in the deletion of the chunks of the content stored on said virtualized resource when said audience parameter indicates a number of accesses to said content below an unpopularity threshold.

11. A content delivery service management entity (10) in a content distribution network, including physical resources capable of hosting at least one virtualized delivery resource, said entity including:
a first transceiver module (100), configured to obtain an audience parameter for a content in one of said physical resources capable of hosting a virtualized delivery resource storing at least one chunk of said content;
a computing module (102), configured to generate an adaptation command for at least one virtualized delivery resource hosted by at least one of said physical resources as a function of said audience parameter;
a transmission module (104), configured to transmit the adaptation command for at least one virtualized delivery resource hosted by at least one of said physical resources as a function of said audience parameter.

12. The content delivery service management entity as claimed in claim 11, furthermore including:
a second transceiver module (108), configured to obtain a distribution of content chunks in said content distribution network;
said computing module being configured to generate the adaptation command for at least one virtualized delivery resource hosted by at least one of said physical resources as a function of said audience parameter and said chunk distribution.

13. A content management system (1) in a content distribution network, including physical resources capable of hosting at least one virtualized delivery resource, said system including:
a content delivery service management entity (10) in a content distribution network, including physical resources capable of hosting at least one virtualized delivery resource, said entity including:
a first transceiver module (100), configured to obtain an audience parameter for a content in one of said physical resources capable of hosting a virtualized delivery resource storing at least one chunk of said content;
a computing module (102), configured to generate an adaptation command for at least one virtualized delivery resource hosted by at least one of said physical resources as a function of said audience parameter;
a transmission module (104), configured to transmit the adaptation command for at least one virtualized delivery resource hosted by at least one of said physical resources as a function of said audience parameter;
a management entity for the virtualized delivery resources (20) hosted by the physical resources of the network, including a transceiver module, configured to send an audience parameter to the content delivery service management entity and to receive an adaptation command for at least one virtualized delivery resource hosted by at least one of the physical resources.

14. A program for a content delivery service management entity, including program code instructions intended to control performance of steps of a method, when said program is executed by said entity, the method for managing contents in a content distribution network (2), including physical resources (30, 40) capable of hosting at least one virtualized delivery resource (31, 32, 41), said method including the following steps, implemented by the content delivery service management entity (10):
obtaining (E2) an audience parameter for a content in at least one of said physical resources capable of hosting a virtualized delivery resource storing at least one chunk (61-64, 71) of said content;
transmitting (E4) an adaptation command for at least one virtualized delivery resource hosted by at least one of said physical resources as a function of said audience parameter.

15. A computer-readable recording medium on which a computer program is recorded, including program code instructions for performance of steps of a method for managing contents in a content distribution network (2), including physical resources (30, 40) capable of hosting at least one virtualized delivery resource (31, 32, 41), said method including the following steps, implemented by a content delivery service management entity (10):
obtaining (E2) an audience parameter for a content in at least one of said physical resources capable of hosting a virtualized delivery resource storing at least one chunk (61-64, 71) of said content;
transmitting (E4) an adaptation command for at least one virtualized delivery resource hosted by at least one of said physical resources as a function of said audience parameter.
